(19) United States
(12) Patent Application Publication
(10) Pub. No.: US 2010/0040458 A1
(43) Pub. Date: Feb. 18, 2010

(54) AXIAL FAN CASING DESIGN WITH CIRCUMFERENTIALLY SPACED WEDGES

(75) Inventor: Peter R. Bushnell, Cazenovia, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: CARRIER CORPORATION, Farmington, CT (US)

(21) Appl. No.: 12/521,318

(22) PCT Filed: Dec. 28, 2006
(86) PCT No.: PCT/US2006/049451

§ 371 Date: Jun. 26, 2009

(51) Int. Cl. F01D 11/08; B23P 11/00

(52) U.S. Cl. 415/173.6; 29/888.025

(57) ABSTRACT

An axial fan assembly including a casing wall with a forward facing step formed therein. Formed on the surface of the step is a plurality of circumferentially spaced wedges which are formed and positioned so as to reduce the swirl flow within the clearance gap between the fan rotor and casing. The wedges are formed so the swirling backflow first encounters a circumferentially tapered face and then an abrupt axially oriented face, thereby substantially removing the swirl component. The wedges have a favorable effect on the flow stability of the fan, thereby extending its operating range. Variations include a fan rotor with a rotating shroud with an outwardly extending portion overlapping the step, and a bellmouth piece at the casing inlet.

### BACKGROUND OF THE INVENTION

This invention relates generally to axial flow fans and, more particularly, to a method and apparatus for reducing their clearance flow losses and improving their operational stability.

Axial flow fans are used in a wide variety of applications, including HVAC, refrigeration, automotive, power systems and aerospace. In each of these applications, performance, noise level, operating range and compactness are important considerations.

Significant losses occur in axial flow fans due to backflow in the clearance region between the fan rotor and the casing. The rotor may utilize conventional blades that extend outward with blade tips approaching the casing, or it may utilize blades that include a rotating shroud attached to the blade tips. In either case backflow is driven from the high pressure side of the rotor to the suction side across the clearance gap, leading to reduced performance, increased noise level and reduced stability and stall-margin.

Various designs have been proposed for increasing fan efficiency by reducing or controlling clearance flows. The designs generally involve an interruption or decrease in the size of the gap. One approach is the use of a tip seal structure wherein a circumferentially extending groove in the casing circumscribes the tips of the blades as shown and described in U.S. Pat. No. 4,238,170. In another approach, an axial fan is provided with a casing having a bellmouth, and the shroud is so formed as to create a separation bubble between the bellmouth and the shroud in order to limit the circulation flow as shown in U.S. Pat. No. 7,086,825 assigned to the assignee of the present invention.

Fan stability is affected by rotating flows within the clearance gap. These flows tend to develop into organized rotating cells which can lead to strong through-flow oscillations and excessive noise.

Various designs have been proposed to improve fan stability by controlling these rotating flows. These designs are generally classified as casing treatment and typically involve grooves or other features extending into the casing wall.

### SUMMARY OF THE INVENTION

Briefly, in accordance with one aspect of the invention, a sharp, forward facing step is provided in the fan casing and a plurality of circumferentially spaced wedges are included on the step of the casing wall to obtain both a restriction in clearance flow losses and increased stability.

By another aspect of the invention, the wedges are so disposed as to have their larger dimension facing the oncoming swirl, and they taper down in the direction of the fan tips rotation.

By yet another aspect of the invention, such a design can be used with or without a rotating shroud. Where a shroud is provided, the shroud wraps around the wedges to force the clearance flow to pass through the wedges and thereby reduce clearance flow. In the non-shrouded fan, the blade tip leading edge extends partially over the wedges, which again serve to reduce the swirl and the clearance flow. In either case, the intent is to delay the onset of rotating stall.

By yet another aspect of the invention, an inlet bellmouth piece is provided to further control the clearance flow.

In the drawings as hereinafter described, a preferred embodiment is depicted; however, various other modifications and alternate constructions can be made thereto without departing from the spirit and scope of the invention.

### BRIEF DESCRIPTION OF THE DRAWINGS

FIG. 1A is a perspective view of an axial fan casing in accordance with one embodiment of the invention.

FIG. 1B is an enlarged view of a portion thereof.

FIG. 1C is a cross sectional view as seen along lines 1C-1C of FIG. 1A.

FIG. 1D is a cross sectional view as seen along lines 1D-1D of FIG. 1A.

FIG. 1E is a cross sectional view as seen along lines 1E-E of FIG. 1A.

FIG. 2A is an axial sectional view of a fan and stator combination with the present invention incorporated therein.

FIGS. 2B and 2C are partial front end and top views respectively, of the wedges and how they affect the airflow.

FIG. 3A is an alternative embodiment thereof with a shrouded fan incorporated therein.

FIGS. 3B and 3C are partial front and top views, respectively of the wedges and how they affect the airflow.

FIG. 3D is a partial sectional view of the blade shroud and the airflow pattern therearound.

FIG. 4 is an alternative embodiment thereof with a bellmouth piece incorporated therein.

FIG. 5 is an alternative embodiment thereof with both a shrouded fan an inlet bellmouth piece incorporated therein.

FIG. 6 is a graphic representation of fan stability behavior as affected by the present invention.

### DESCRIPTION OF THE PREFERRED EMBODIMENT

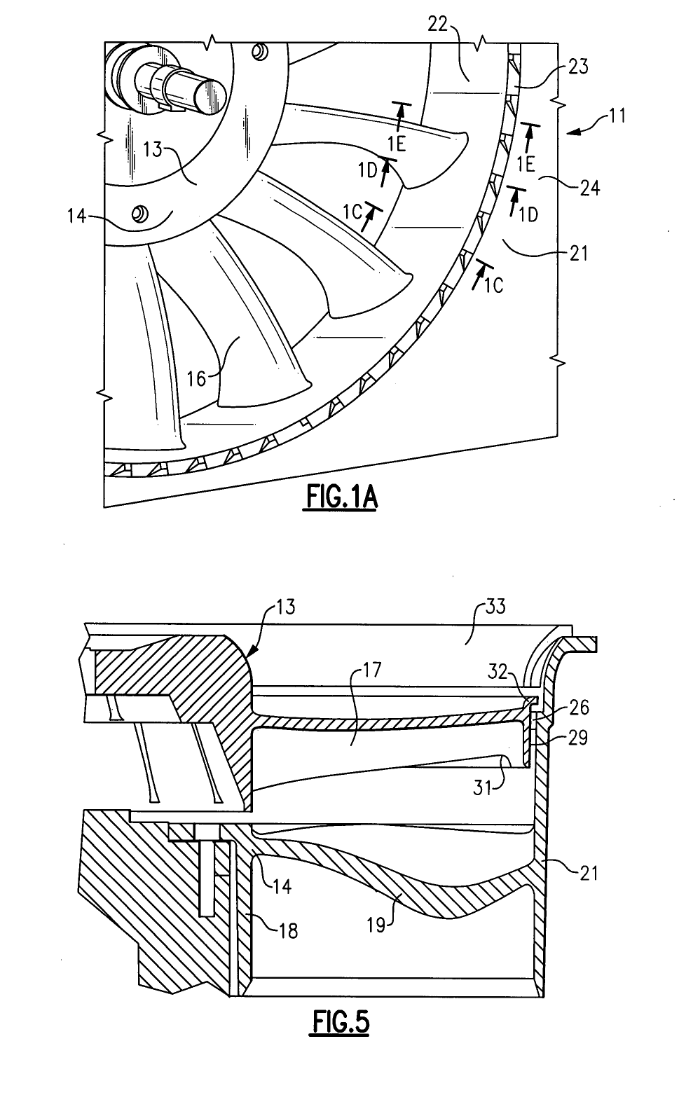

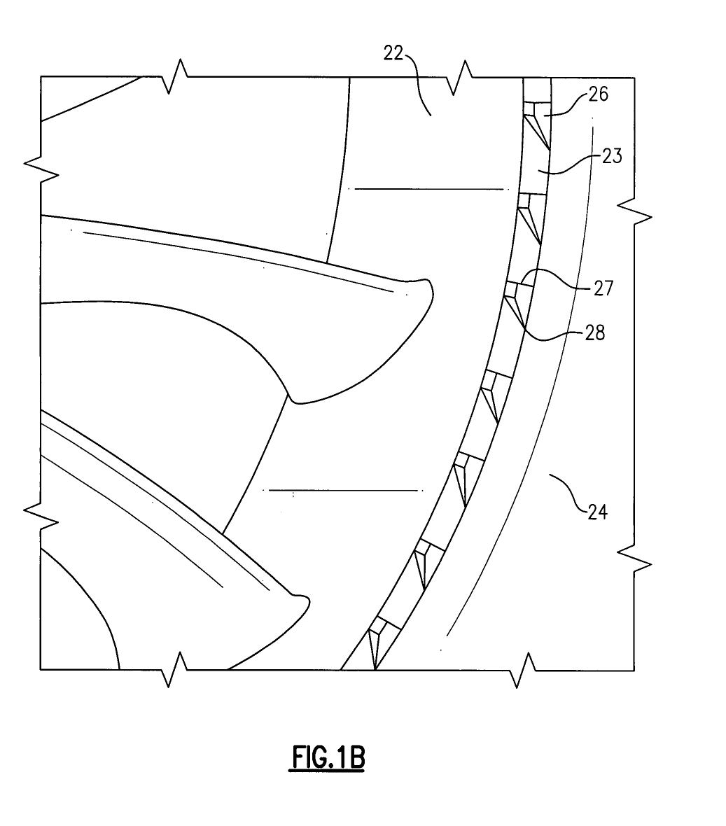

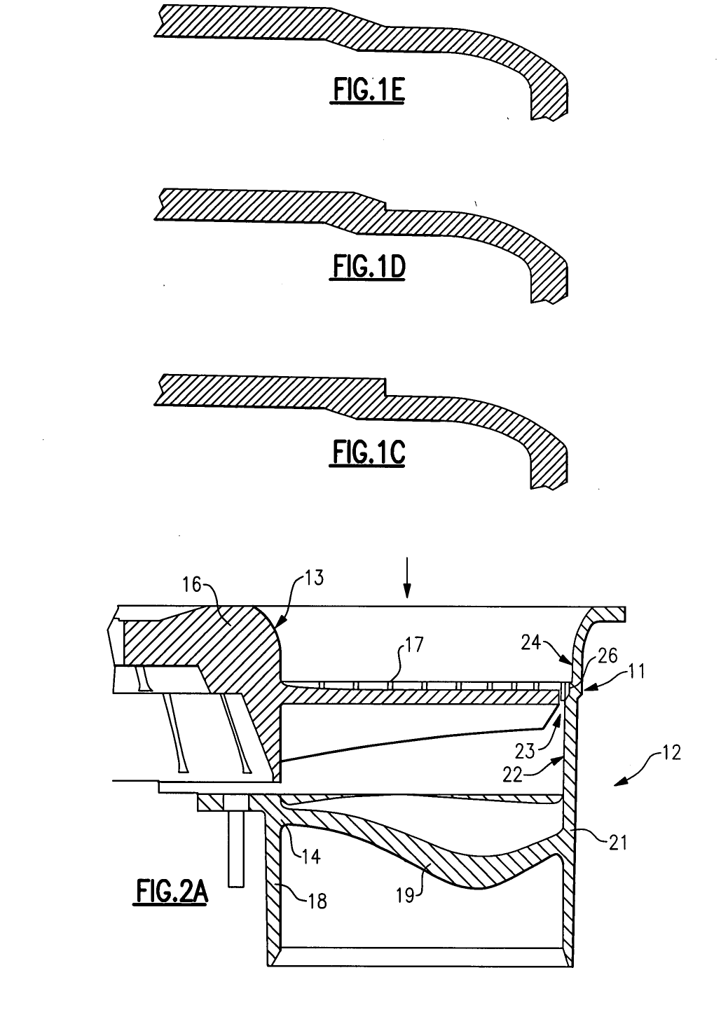

Referring now to FIGS. 1A thru 1E and 2A, the invention is shown generally at 11 as applied to an axial fan assembly that includes in serial airflow relationship, an axial fan 13 and a stator 14. The axial fan 13 includes a rotatable hub 16 and a plurality of fan blades 17. The stator 14 includes a stationary hub 18 and a plurality of radially extending stationary vanes 19 having their radially outer ends integrally connected to a cylindrical outer casing 21. In operation, the fan 13 is rotated at relatively high speeds to induce the flow of air through the casing 21, and in the process it creates a swirl in the direction of the fan rotation. The stator vanes 19 are so disposed and shaped so as to substantially remove the swirl from the main air flow stream such that the flow at the downstream end is substantially axial in direction.

As is well known in the art, the dimensions of the fan blade 17 are such that the radial clearance between the ends of the fan blades 17 and the inner diameter of the casing 21 are as small as possible but without engagement between the two elements. Because of this necessary radial clearance, there is a tendency for the air within the casing 21 to flow back through the radial gap to the forward side of the fan 13. This results directly in reduced pressure rise and efficiency. In addition, swirl flow in the backflow gap tends to destabilize the fan, leading to further performance degradation and reduction of the operating range. This stability limitation is found as the fan is progressively throttled down from a high flow rate to low flow operation and is generally referred to as the stall limit. In some cases, fan stall can produce strong surging of the main through-flow, generating violent pressure fluctuations and noise. An object of the present invention is to significantly reduce the swirl in the backflow gap and improve fan stability.

It will be seen that the inner surface of the casing 21 comprises three interconnected surfaces 22, 23 and 24. The surface 22 is axially aligned and surrounds the axial fan 13. The surface 23 is substantially radially aligned and comprises a radially outwardly extending step. The surface 24 is curvilinear and expands outwardly as it extends upstream into the oncoming airflow stream.

Formed on the surface 23 is a plurality of circumferentially spaced wedges 26 having their greater dimension on a side 27 that is facing the tangential direction of the fan blade tips. Wedges 26 then taper down to a point 28 as they extend circumferentially in the direction of the fan blade movement.

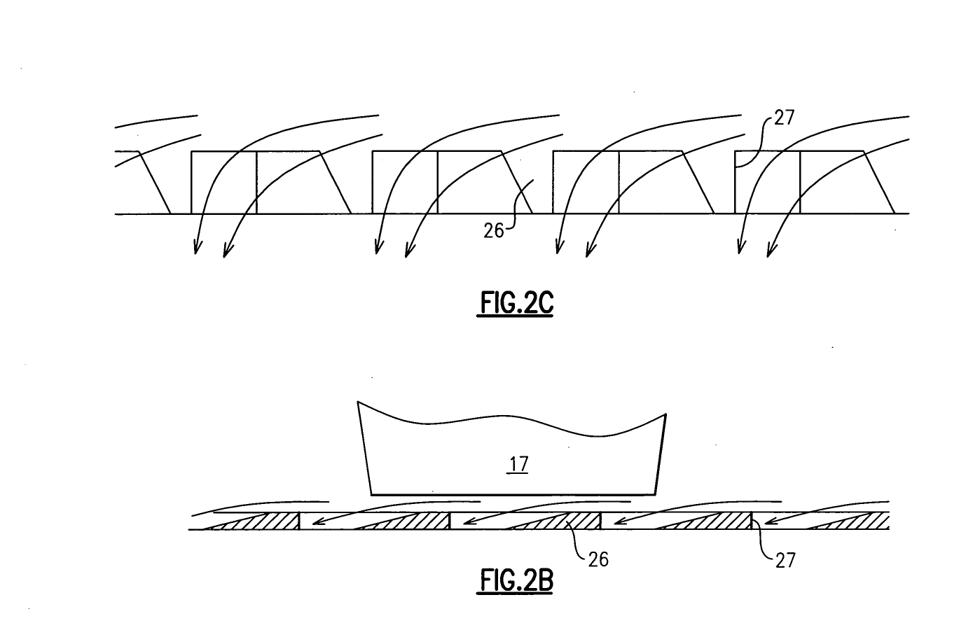

The wedges function by redirecting the swirl flow in the clearance region into the axial direction. FIGS. 2B and 2C show an un-wrapped representation of the clearance gap, wedges and gap flow behavior. A fraction of the oncoming backflow pours into the gaps between the distal wedge features and is then blocked in the tangential direction by the substantially axial faces 27. The number of wedges may vary from as few as 10 to over 100 with their circumferential length varying accordingly. The wedges are arranged so as to be producible using axially straight-pull tooling using injection molding or die casting. The wedge height may be varied from 0.05 to 5 times the radial clearance gap as will best meet the requirements for a particular design.

Referring now to FIG. 3A, the axial fan assembly is shown in another embodiment wherein the fan rotor 13 includes a shroud 29 which is integrally connected to the tips of the fan blades 17 and surrounds the fan in a well known manner. The shroud 29 includes a substantially cylindrical portion 31 towards its downstream end and a radially outwardly extending portion 32 near its upstream end. As will be seen, the radially extending portion 32 overlaps the surface 23 and the wedges 26, so as to provide a further barrier to the backflow of air through the gap. The effect of the wedges on the swirl flow is basically similar whether the fan includes a rotating shroud or not, as will be seen in FIGS. 3A and 3B. However, the rotating shroud provides further opportunity for flow restriction and reduces the interaction of the clearance flow with the fan blades as will be seen in FIG. 3D. The later point leads to the well known associated noise reduction potential. When a rotating shroud is used, the radially extending portion 32 should vary along with the choice of wedge height as discussed hereinabove.

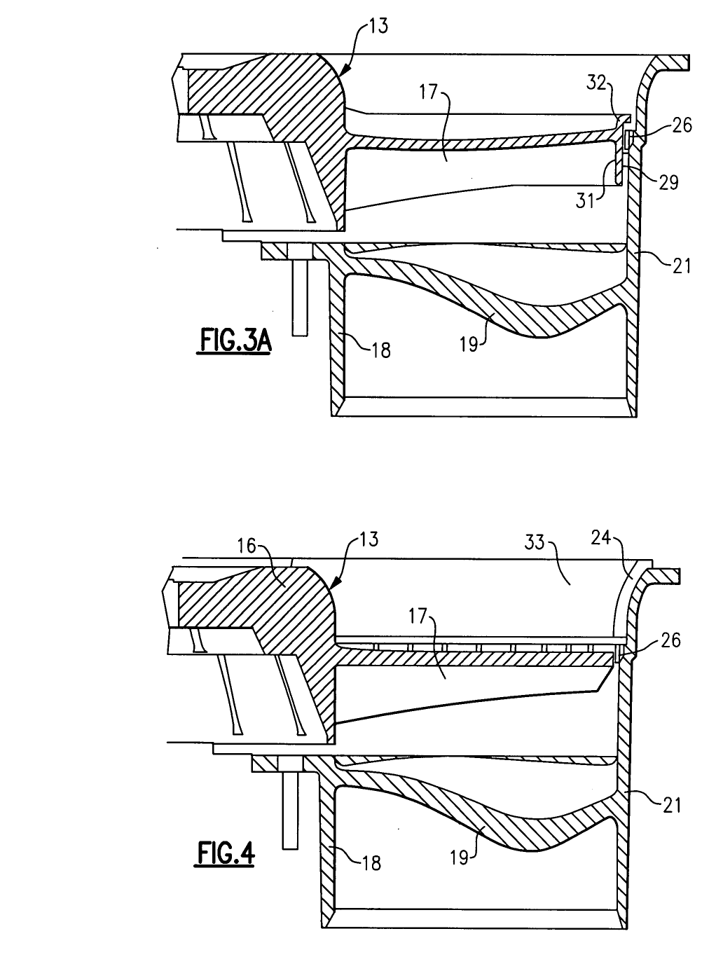

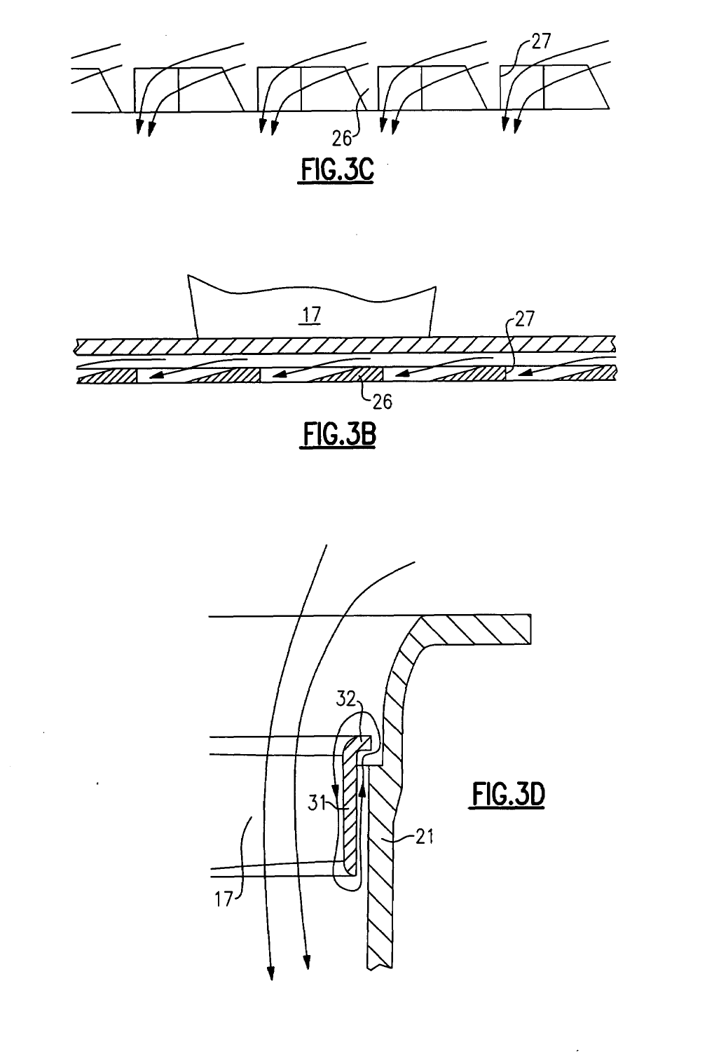

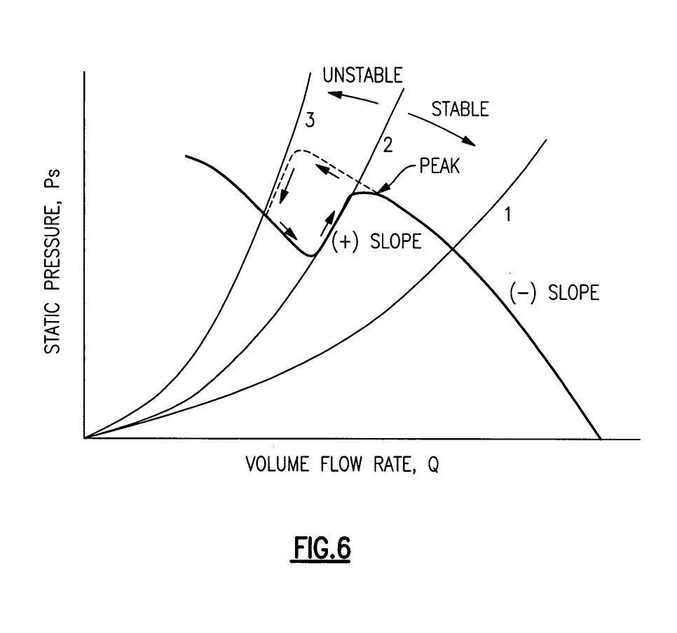

In the FIG. 4 embodiment, the axial fan 17 does not include a shroud but an inlet bellmouth piece 33 is included by way of a close fit relationship with the surface 24. The bellmouth piece 33 acts to improve the inflow of air into the assembly and to reduce backflow loss by further restricting the clearance gap region.

In the FIG. 5 embodiment, both a fan shroud 29 and a bellmouth piece 33 are included to provide the improvements as discussed hereinabove.

In FIG. 6 there is shown a graphic illustration of the relationship between airflow rate and static pressure as it affects fan stability behavior. The solid line represents the behavior without the present invention and the dotted line represents the behavior with the invention. Relative to the solid line curve, operation on throttle line 1 is stable operation while operation on throttle line 2 is unstable. Between lines 2 and 3, operation is unstable with hystersis and surge. With the use of wedges as described, the operational curve is moved up to the position as shown by the dotted lines to thereby increase the range of stable operation.

We claim:

1. A method of decreasing the quantity of clearance backflow and associated swirl in an axial fan assembly, having a fan rotor and a closely surrounding casing, comprising:
a) providing a forward facing step in the casing, said step being axially positioned so as to surround the blade tips of said fan; and
b) providing a plurality of circumferentially spaced wedges on the surface of said step, said wedges being positioned so as to reduce the backflow swirl component in the assembly.

2. A method as set forth in claim 1 wherein said forward facing step comprises a substantially radially extending surface.

3. A method as set forth in claim 1 wherein said wedges are positioned with their greater dimension facing the oncoming swirl, and are tapered in the direction of blade rotation.

4. A method as set forth in claim 1 and including the provision of a rotating shroud attached to the blade tips of said fan rotor.

5. A method as set forth in claim 4 wherein said shroud includes an outwardly extending portion on its forward end, with said outwardly extending portion partially overlapping the said forward facing step.

6. A method as set forth in claim 1 and including the provision of a bellmouth piece at the inlet of said casing.

7. An axial fan apparatus comprising:
a fan having a hub with a plurality of blades extending therefrom;
a casing closely surrounding said plurality of blades and having formed in its radially inner surface a forward facing step structure that is axially disposed around the tips of said plurality of blades; and
a plurality of circumferentially spaced wedges formed on the face of said step structure so as to reduce backflow swirl.

8. An axial fan apparatus as set forth in claim 7 wherein said forward facing step structure is orientated in a substantially radially extending direction.

9. An axial fan apparatus as set forth in claim 7 wherein said plurality of circumferentially spaced wedges are disposed with their greater dimension facing the tangential direction of fan rotation and tapering in the direction of rotation.

10. An axial fan apparatus as set forth in claim 7 and including a shroud interconnecting and surrounding said plurality of blades.

11. An axial fan apparatus as set forth in claim 10 wherein said shroud includes a radially outwardly extending portion which overlaps a portion of said forward facing step structure.

12. An axial fan apparatus as set forth in claim 7 and including a bellmouth piece attached to an upstream end of said casing.
